(19) United States
(12) Patent Application Publication
(10) Pub. No.: US 2010/0332718 A1
(43) Pub. Date: Dec. 30, 2010

(54) SYSTEM AND METHOD FOR PROVIDING CONFIGURABLE LATENCY AND/OR DENSITY IN MEMORY DEVICES

(75) Inventors: Todd D. Farrell, Boise, ID (US); Christopher S. Johnson, Meridian, ID (US)

Correspondence Address: FLETCHER YODER (MICRON TECHNOLOGY, INC.), P.O. BOX 692289, HOUSTON, TX, 77269-2289, US

(73) Assignee: Micron Technology, Inc., Boise, ID (US)

(21) Appl. No.: 12/492,752

(22) Filed: Jun. 26, 2009

(51) Int. Cl. G06F 12/00; G06F 12/06

(52) U.S. Cl. 711/5; 711/105; 711/E12.001

(57) ABSTRACT

Memory devices, memory controllers, methods, and systems are provided, such as methods for masking the row cycle latency time of a memory array. In one embodiment, a memory device that is configurable to operate in full or reduced density modes is provided. In a reduced density mode, certain banks within the memory array function as duplicate memory banks associated with an addressable memory bank. Write operations performed in the reduced density mode may write a data segment to an addressed memory bank as well as its associated duplicate banks. When repeated read requests are issued for the data segment, the read requests may be interleaved between the addressed bank and its duplicate banks, thereby masking the row cycle time of each physical bank. That is, the interval between each read out of the data segment from the memory array will appear to be less than the row cycle time.

### BACKGROUND

1. Field of the Invention

Embodiments of the invention relate generally to the field of memory devices. More specifically, embodiments of the present invention may provide one or more techniques for reducing latency times in memory devices.

2. Description of the Related Art

Electronic devices typically utilize one or more memory devices, such as a dynamic random access memory (DRAM), for storing data that may be used by the electronic device. For instance, the stored data may represent applications, media, an operating system, or any other type of suitable data that may be used by the electronic device. Typically, a memory device, such as a synchronous DRAM (SDRAM), includes a memory array divided into a plurality of memory banks, or other divisions. Based upon addressing information received by the memory device during operation, data may be stored into and read out of appropriate banks of the memory array.

The rate at which data may be read from a memory array is typically limited by the row cycle latency time (tRC) of the memory array, which may be defined as the minimum time interval that must elapse between issuing successive ACTIVE commands to the same physical bank of the memory array. By way of example, in a DDR2 SDRAM device, a typical tRC may be approximately 55 ns. As will be appreciated, due to tRC limitations, random read requests to the same physical bank must wait for tRC to elapse before a subsequent read may be performed. Thus, in applications where there is a need to issue repeated random read requests for reading a particular segment of data from a memory device at high speeds and low cycle times, it may be desirable to reduce the effective tRC of the memory device.

Some conventional solutions for addressing the latency drawbacks of conventional DRAM memory devices include providing low latency static RAM (SRAM) devices or reduced latency DRAM (RLDRAM) devices in place of conventional SDRAM devices. While such devices are capable of providing a lower tRC, such devices are also generally substantially higher in cost relative to SDRAM devices. Additionally, SRAM and RLDRAM devices also typically have higher power consumption requirements relative to SDRAM devices offering a similar storage capacity.

Another conventional technique for reducing tRC includes providing a copy of the requested read data to each of a plurality of DRAM devices and interleaving read requests among the plurality of DRAM devices. However, this technique not only requires that multiple DRAM devices be provided, but may also require a separate control circuitry to manage the interleaving of of read requests between the multiple devices, thus disadvantageously increasing costs, bus turn-around times, and amount of component space required relative to using a single memory device.

Accordingly, embodiments of the present invention may be directed to one or more of the problems set forth above.

### BRIEF DESCRIPTION OF THE DRAWINGS

FIG. 1 is simplified block diagram illustrating an example of a memory device that may incorporate configurable density and latency features, in accordance with an embodiment of the invention;

FIG. 2 is a simplified block diagram showing a layout of a memory array that may be used in the memory device of FIG. 1 and depicting a write operation for writing a segment of data to the memory array when operating in a full density configuration, in accordance with an embodiment of the invention;

FIG. 3 is a timing diagram depicting read operations for reading the segment of data from the memory array when operating in the full density configuration illustrated in FIG. 2, in accordance with an embodiment of the invention;

FIG. 4 is a simplified block diagram depicting a write operation for writing a segment of data to the memory array when operating in a half-density configuration, in accordance with an embodiment of the invention;

FIG. 5 is a timing diagram depicting read operations for reading the segment of data from the memory array when operating in the half-density configuration illustrated in FIG. 4, in accordance with an embodiment of the invention;

FIG. 6 is a simplified block diagram depicting a write operation for writing a segment of data to the memory array when operating in a quarter-density configuration, in accordance with an embodiment of the invention;

FIG. 7 is a timing diagram depicting read operations for reading the segment of data from the memory array when operating in the quarter-density configuration illustrated in FIG. 6, in accordance with an embodiment of the invention;

FIG. 8 is a simplified block diagram showing an alternate layout of a memory array that may be used in the memory device of FIG. 1;

FIG. 9 is a simplified block diagram depicting a write operation for writing first and second segments of data to the memory array shown in FIG. 8 when operating in a quarter-density configuration, in accordance with a further embodiment of the invention;

FIG. 10 is a timing diagram depicting read operations for reading the first segment of data from the memory array when operating in the quarter-density configuration illustrated in FIG. 9, in accordance with a further embodiment of the invention;

FIG. 11 is a timing diagram depicting read operations for reading the first and second segments of data from the memory array when operating in the quarter-density configuration illustrated in FIG. 9, in accordance with a further embodiment of the invention;

FIG. 12 is a flowchart depicting a method for writing a segment of data to a memory device, in accordance with an embodiment of the invention; and

FIG. 13 is a flowchart depicting a method for reading data from a memory device, in accordance with an embodiment of the invention.

### DETAILED DESCRIPTION

One or more embodiments of the present invention relate to techniques for masking the row cycle time of a memory array. In one embodiment, a memory device that is configurable to operate in full or reduced density modes is provided. When operating in a reduced density mode, certain banks within such a memory array of the device may function as duplicate memory banks associated with a directly addressable memory bank. Thus, a write operation performed in a reduced density mode may not only write a data segment to the memory bank addressed by a write command, but may further duplicate the data segment by creating a copy of the data segment in each duplicate bank associated with the directly addressed bank. When repeated read requests are initiated for the data segment, the read requests may be interleaved between the addressed bank and its duplicate banks. Using such an interleaving technique, the interval between each read out of the data segment from the memory array is less than the row cycle time of each bank. As will be discussed further below, such embodiments of the present invention are particularly well-suited for applications in which a generally fixed or static segment of data is subject to a high rate of read requests. For instance, techniques disclosed herein may be implemented in the context of a network device, particularly where generally static lookup tables or network translation tables are repeatedly read. These and other features, aspects, and advantages will be discussed in further advantages will be discussed in further detail with regard to the following description of various embodiments of the present invention.

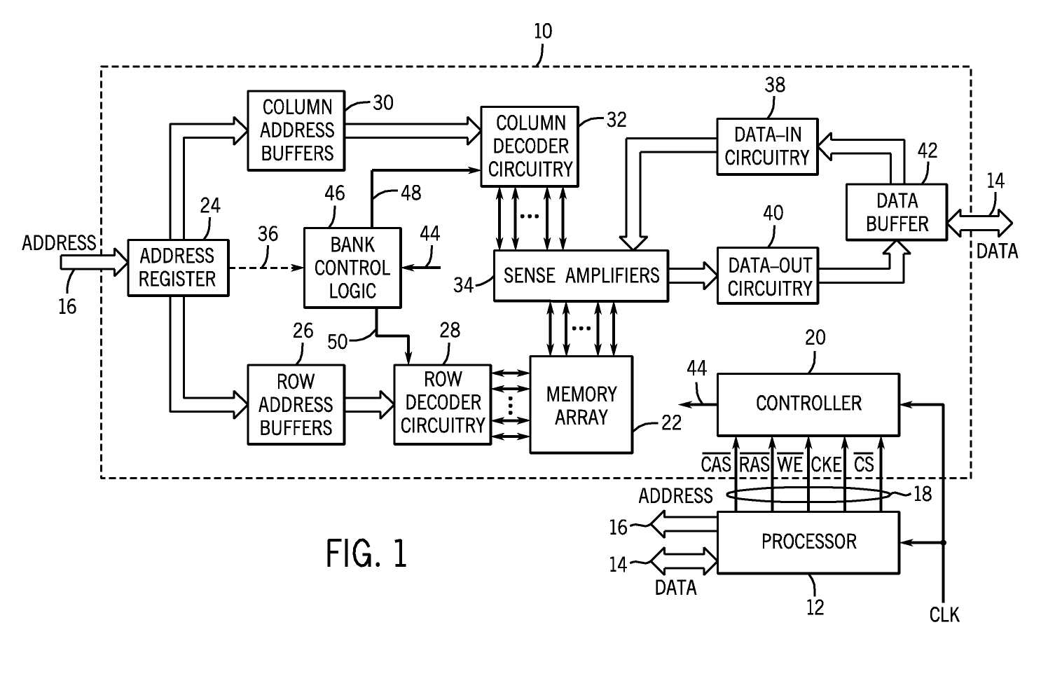

Keeping the foregoing points in mind and turning now to FIG. 1, a block diagram depicting an embodiment of a memory device 10 that may implement embodiments of the present invention is illustrated. By way of example, the memory device 10 may be a synchronous dynamic random access memory (SDRAM) using a double-data-rate (DDR) architecture. While the present disclosure may refer to the memory device 10 broadly, in certain embodiments, such as a DDR SDRAM, it should be understood that the term DDR may encompass DDR, DDR2, or DDR3 technologies. Further, it should be understood that the following description of the memory device 10 has been simplified for illustrative purposes and is not intended to be a complete description of all features of an actual memory device. Further, the present technique is not necessarily limited to DDR SDRAMs, and may also be implemented in other types of dynamic random access memories (DRAM), such as SDR, DDR, DDR2, DDR3, and DDR4 devices, to name just a few. Indeed, those skilled in the art will recognize that various devices may be used in the implementation of embodiments of the present invention.

The memory device 10 may be a component of an electronic device, such as a computer, portable media player, mobile phone, personal digital assistant, or a network router/switch, for instance. As shown in FIG. 1, control, address, and data information provided over a memory bus are represented by individual inputs to the memory device 10. These individual representations are illustrated by a data bus 14, an address bus 16, and various discrete lines providing control signals 18 directed to a memory controller 20. The memory device 10 also also includes a memory array 22 which may include rows and columns of addressable memory cells. As can be appreciated by those skilled in the art, the terms “row” and “column” may refer to a logical configuration of the memory, and do not necessarily refer to a specific linear relationship or orientation of the memory cells. As will be further appreciated, each memory cell in a row may be coupled to an access line, which is also referred to as a word line, and each memory cell in a column may be coupled to a data line, which is also referred to as a digit line or a bit line. Further, each cell in the memory array 22 typically includes a storage capacitor and an access transistor. Thus, in operation of conventional devices, a word line and bit line may be utilized to access a storage capacitor through a respective access transistor of an addressed memory cell, for instance.

The memory device 10 may interface with a memory access device, for example, a processor 12, such as a microprocessor, by way of the data bus 14 and address bus 16. Alternatively, the memory device 10 may interface with other memory access devices, such as an SDRAM controller, a microcontroller, a chip set, or other electronic system or device. As shown, the processor 12 may also provide a number of control signals 18 to the memory device 10. Such signals may include row and column address strobe signals RAS and CAS, a write enable signal WE, a clock enable signal CKE, a chip select signal CS, and other conventional control signals. By way of these control signals 18, the controller 20 may control the many available functions of the memory device 10, including the selection of operating the memory device 10 in either a full density or reduced density mode, as will be discussed in further detail below. In addition, various below. In addition, various other control circuits and signals not detailed herein may contribute to the operation of the memory device 10, as can be appreciated by those of ordinary skill in the art.

Address information from the address bus 16 may be received in the memory device 10 using the address register 24. A row address buffer 26 and row decoder circuitry 28 may receive and decode row addresses from the row address signals received by the address register 24. Each unique row address may correspond to a row of cells in the memory array 22. The row decoder 28 typically includes a word line driver, an address decoder tree, and circuitry which translates a given row address received from the row address buffer 26 and selectively activates the appropriate word line of the memory array 22 by way of the word line drivers.

The memory device 10 may also include a column address buffer 30 and column decoder circuitry 32 configured to receive and decode column address signals received by the address register 24. The column decoder 32 may also determine when a column within the memory array 22 is defective, as well as provide the address of a replacement column. As shown, the column decoder 32 is coupled to sense amplifiers 34, each of which may be coupled to complementary pairs of bit lines within the memory array 22.

In the present embodiment, the sense amplifiers 34 are coupled to data-in (e.g., write) circuitry 38 and data-out (e.g., read) circuitry 40. The data-in circuitry 38 and the data-out circuitry 40 may include I/O gating circuitry, data drivers, and latches configured to provide input and output data on the data bus 14 of the memory device 10. The data-in circuitry 38 and data-out circuitry 40 may be further coupled to a data buffer 42, which may include one or more buffers for buffers for delaying, regenerating, and storing data signals communicated between the processor 12 and the memory device 10. For instance, during a write operation, the data bus 14 provides data to the data-in circuitry 38. The sense amplifiers 34 receive the data from the data-in circuitry 38 and store the data to corresponding cells in the memory array 22, for example, as a charge on a capacitor of a memory cell located at an address specified on the address bus 16. By way of example only, the data bus 14, in one embodiment, may be an 8-bit data bus capable of transferring data at a frequency of 400 MHz or higher.

During a read operation, the memory device 10 transfers data to the processor 12 from the memory array 22. Complementary bit lines for the accessed cell are equilibrated during a precharge operation to a reference voltage provided by an equilibration circuit (not shown) and a reference voltage supply. The charge stored in the accessed cell is then shared with the corresponding bit lines. The sense amplifier 34 then detects and amplifies a difference in voltage between the complementary bit lines. The address information received on address bus 16 is used to select a subset of the bit lines, which is then coupled to complementary pairs of input/output (I/O) wires or lines. The I/O wires pass the amplified voltage signals to the data-out circuitry 40, the data buffer 42, and eventually out to the data bus 14 to be transmitted to the processor 12.

The data-out circuitry 40 may include a data driver (not shown) to drive data out onto the data buffer 42 and the data bus 14 in response a read request directed to the memory array 22. Further, the data-out circuitry 40 may include a data latch (not shown) to latch the read data until it is driven out onto the data buffer 42 and the data bus 14 by the data driver. Though not shown in in the present embodiment, it should be appreciated that a synchronization device, such as a delay lock loop circuit (DLL) may be utilized to provide a shifted clock signal that is synchronous with an external system clock CLK, thus synchronizing the output data signal with the system clock CLK.

As will be appreciated, the memory array 22 may be divided into a plurality of logical banks. Each logical bank may further include a plurality of addressable physical banks. By way of example only, the memory array 22 may be a 1 gigabit (Gb) array providing 8 logical banks and 16 physical banks, such that each logical bank includes 2 physical banks, each capable of storing 64 megabits (Mb) of data. Before any READ or WRITE commands may be issued to a particular memory bank, a row in that bank is activated. This is typically accomplished using an ACTIVE command, which may be initiated by low CS and RAS signals in combination with high CAS and WE signals occurring during the rising edge of the CLK signal. During the ACTIVE command, bank address signals 36 may be provided to bank control logic 46 via the address register 24. The bank control logic 46 may further provide the bank address signals 36 to the row decoder circuitry 28 and column decoder circuitry 32, as indicated by control signals 48 and 50, respectively. Based upon the row address signals, column address signals, and bank address signals, an appropriate memory bank within the memory array 22 may be activated.

As discussed above, the memory device 10 may be capable of operating in a full density mode or in one or more reduced density modes. In a full density mode of operation, all 8 logical banks may be directly addressable. That is, a memory access device, such as a processor, external to the memory device 10 may directly address each bank of the memory array 22 in a full full density mode of operation. As will be appreciated, each physical bank of a memory array has a row cycle latency time (tRC), which may be generally defined as the minimum time interval that must elapse between issuing successive ACTIVE commands to the same bank of the memory array 22. Generally, the tRC may be determined as the sum of the minimum RAS active time (tRAS) and the row precharge time (tRP) of the memory array 22. For instance, the tRC may be expressed by the following formula:

tRC=tRAS+tRP

By way of example only, a DDR2 SDRAM memory device utilizing the 8-logical bank/16-physical bank arrangement discussed above may have a tRC of approximately 55 ns.

When the memory device 10 operates in a reduced density mode, the memory array 22 may utilize a reduced bank count, in which only a portion of the number of banks within the memory array 22 are directly addressable by external commands (e.g., issued by the processor 12). For the purposes of the present disclosure, the term “directly addressable bank” or the like shall be understood to mean a memory bank that is directly addressable by something external to the memory device. For instance, in a reduced density mode, only half or a quarter of the banks within the memory array 22 may be directly addressable. Additionally, the term “inactive bank” shall be understood to mean a memory bank that is not a directly addressable bank. While the term “inactive” is used to describe such memory banks, it should be understood that these memory banks are not literally “inactive.” As will be explained in further detail below, when operating in a reduced density mode, “inactive banks” may be associated with a directly addressable bank and may function as a duplicate bank to which data written to the associated directly addressable bank directly addressable bank is duplicated. In this manner, the speed at which read requests for a segment of data stored in a particular directly addressable bank are read out from the memory array may overcome the inherent tRC of the memory array 22 by interleaving the reading of the requested data segment between the directly addressable bank and one or more associated duplicate banks.

Referring still to FIG. 1, the selection of whether to operate in a full or reduced density mode may be determined by the memory controller 20. For example, the memory controller 20 may receive a command from the processor 12 that may be translated into a particular desired mode of operation (e.g., full or reduced density). Depending on the mode of operation requested, the controller 20 may supply appropriate control actions 44 to the bank control logic 46 in order to configure the memory array 22 to operate in either a full density mode or a reduced density mode, such as a half-density mode or quarter-density mode. Further, as will be discussed in additional detail below, depending on the density mode of operation selected, the controller 20 may implement appropriate WRITE and READ algorithms for writing data to and reading data from the memory array 22.

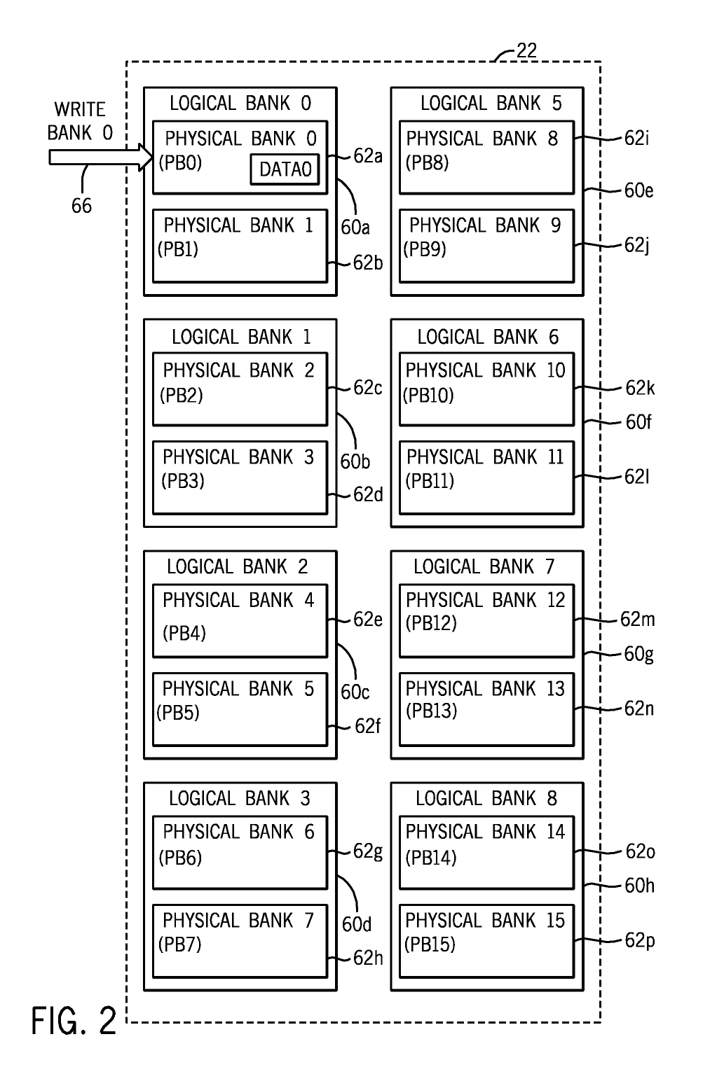

Referring now to FIG. 2, a simplified block diagram of the memory array 22 utilizing the 8-logical bank/16-physical bank memory layout discussed above is illustrated. As shown, the illustrated array 22 includes 8 logical memory banks numbered 0-7 and referred to by the reference numbers 60a-60h, respectively, and includes 16 physical banks numbered 0-15 and referred to by the reference numbers 62a-62p, respectively, wherein each logical bank 60 includes two physical banks 62. For instance, logical bank 0 (60a) includes physical banks 0 (62a) and 1 (62a) and 1 (62b). Logical bank 1 (60b) includes physical banks 2 (62c) and 3 (62d). Logical bank 2 (60c) includes physical banks 4 (62e) and 5 (62f). Similarly, logical bank 3 (60d) includes physical banks 6 (62g) and 7 (62h), and logical bank 4 (60e) includes physical banks 8 (62i) and 9 (62j). Further, logical bank 5 (60f) includes physical banks 10 (62k) and 11 (62l), logical bank 6 (60g) includes physical banks 12 (62m) and 13 (62n), and logical bank 7 (60h) includes physical banks 14 (62o) and 15 (62p).

To provide some examples, the memory array 22, in one embodiment, may be a 1 GB array in which each logical bank 60 has a size of 128 Mb, and each physical bank 62 has a size of 64 Mb. In another embodiment, the memory array 22 may be a 2 Gb array in which each logical bank 60 has a size of 256 Mb and each physical bank 62 has a size of 128 Mb. It should be understood that the presently illustrated embodiment is only meant to provide one example of a particular layout that may be implemented. In other embodiments, any suitable type of memory bank layout may be utilized, such as an 8-logical bank/32-physical bank layout or a 4-logical bank/16-physical bank layout (e.g., each having 4 physical banks per logical bank).

As illustrated by FIG. 2, the memory device 10 is shown operating in a full density mode, in which each logical bank 60a-60h is directly addressable by the processor 12, for example. As shown here, a WRITE command to logical bank 0 (60a) may write a data segment DATA0 into physical bank 0 (62a). Because the memory device 10 is operating in a full density mode, the full tRC (e.g., 55 ns) is utilized between each read command issued to logical bank 0 (60a) for reading DATA0 from physical bank 0 (62a).

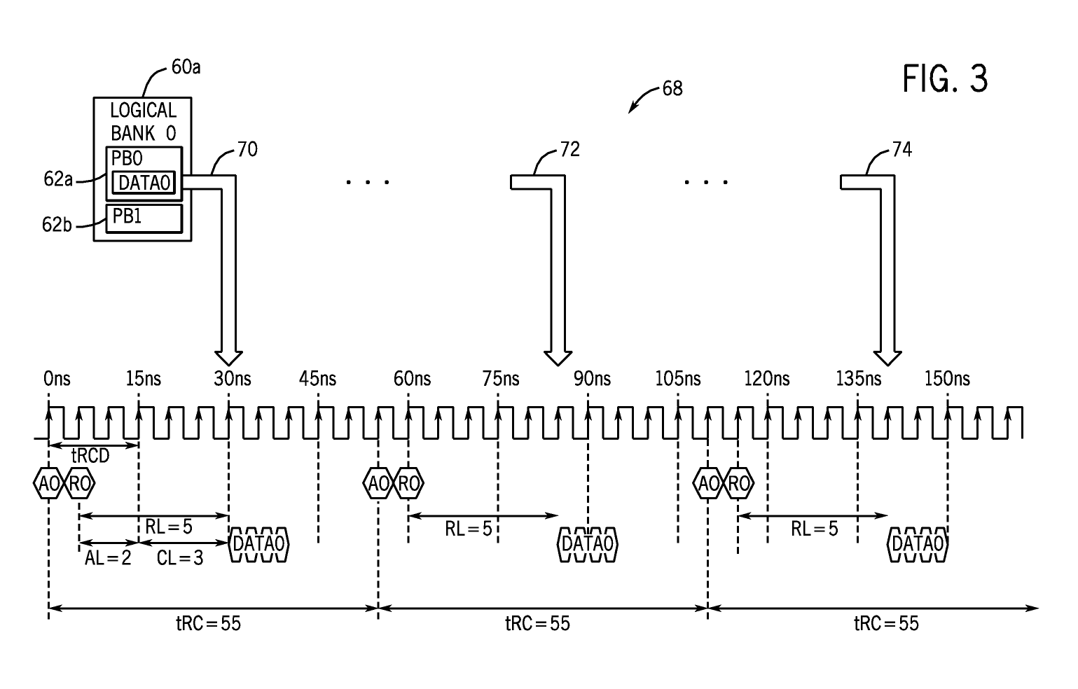

Referring now to FIG. 3, a timing diagram 68 depicting read operations for reading DATA0 from physical bank 0 (62a) of logical bank 0 (60a) of the memory array 22 when operating in the full density mode is illustrated. In the present example, the timing diagram 68 is based upon a clock cycle of 5 ns from between rising edges, although it should be understood that clock cycles of different lengths may be used in other embodiments. During a first clock cycle at 0 ns, an ACTIVE command (A0) to activate bank 0 is issued, followed by a READ command (R0) to read DATA0 from logical bank 0. As shown here, a row address to column address delay (tRCD), which represents the number of clock cycles for issuing an ACTIVE command and a READ command, is three clock cycles. Following a read latency (RL) of 5 clock cycles, which includes an additive latency (AL) of 2 clock cycles and a CAS latency (CL) of 3 clock cycles following the READ command (R0), DATA0 may be read from physical bank 0 (62a) of logical bank 0 (60a) at 30 ns, as indicated by the reference number 70. As discussed above, DATA0 may be read from the memory array by accessing the particular memory cells at which DATA0 is stored. The charge stored in the cells may be translated into amplified voltage signals using the sense amplifiers 34 and provided to the data-out circuitry 40 and to the data bus 14.

As discussed above, due to the tRC of the physical bank in which DATA0 is stored (e.g., physical bank 0 (62a)), subsequent ACTIVE and READ commands to read DATA0 from physical bank 0 (62a) may not be issued until the tRC has elapsed. As shown in the timing diagram 68, if the tRC is 55 ns, a subsequent ACTIVE command (A0) and READ command (R0) may not be issued to physical bank 0 (62a) until 55 ns after the original ACTIVE command (A0). Then, following the read latency time of 5 clock cycles, DATA0 may be read out from physical bank 0 (62a) again at 85 ns, as indicated by the reference number 72. Thus, it should be understood that the interval between the time (30 ns) at which DATA0 was read out during the first read command and the time (85 ns) at which DATA0 is read out during the second read command is equivalent to the tRC of the memory array 22, which is 55 ns in the present example.

Following the second read command, a third read command may be issued at 110 ns (55 ns after issuing the previous ACTIVE command), and may include an ACTIVE command (A0) for activating physical bank 0 (62a). As depicted by the timing diagram 68, following a READ command (R0) at 115 ns, DATA0 may be read out from physical bank 0 once again at 140 ns. Thus, when operating in full density mode, the frequency at which DATA0 may be read from the memory array is limited by the tRC. As shown above, where the tRC is 55 ns, physical bank 0 (62a) may be issued ACTIVE commands at the times 0 ns, 55 ns, and 110 ns, and DATA0 may be read from physical bank 0 (62a) at times 30 ns, 85 ns, and 140 ns, respectively.

While the present full tRC may be suitable for some applications, in certain applications it may be desirable to provide a reduced effective tRC, such that DATA0 may be read out more frequently (e.g., at a faster rate). For instance, in applications where DATA0 represents a generally static segment of data in high demand, it may be desirable to utilize a reduced density mode of operation in accordance with aspects of the present technique in order to provide a reduced latency time between each READ command such that DATA0 may be read from the memory array more frequently. By way of example, one such application may pertain to high speed network routers. Such systems typically store a fixed segment or segments of data in the form of a lookup table or Network Address Translation (NAT) table that is generally written once (or infrequently) to a memory device. Such lookup tables or NAT tables are typically read out at typically read out at high speeds and low cycle times to provide internet protocol (IP) address translation and/or port mapping/forwarding.

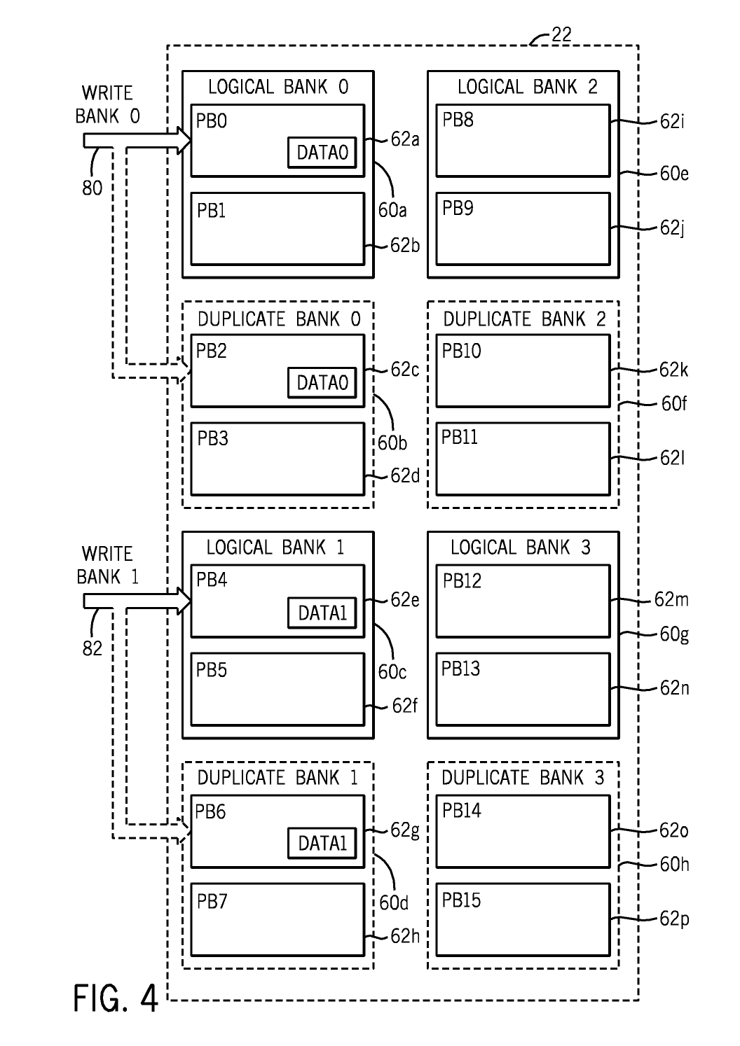

As discussed above, a reduced effective tRC may be provided by operating the memory array 22 in a reduced density mode. Referring now to FIG. 4, the memory array 22 shown in FIG. 2 is illustrated in a half-density mode of operation. As shown, half of the logical banks 60 within the memory array 22 remain as directly addressable banks, and the other half of the logical banks 60 are configured as inactive “duplicate” banks, each associated with a respective directly addressable bank. By way of example, in the present configuration, the directly addressable logical banks 60a, 60c, 60e, and 60g are each associated with a duplicate bank 60b, 60d, 60f and 60h, respectively. It should be appreciated that the present configuration is merely one example of a half-density configuration, and that other embodiments may utilize other configurations. For instance, in another embodiment, logical banks 60a-60d may be directly addressable banks and logical banks 60e-60h may be associated with the duplicate banks, and so forth. It should be understood that regardless of the particular logical banks chosen as either directly addressable or inactive duplicate banks, the illustrated half-density configuration associates one duplicate bank to each addressable bank.

As mentioned above, when operating in a reduced density mode, the memory controller 20 may implement appropriate WRITE and READ algorithms for facilitating a reduced tRC when reading data from the memory array 22. As shown in FIG. 4, write commands that may be performed in the half-density mode of operation are illustrated. For instance, the WRITE command 80 represents a command to write DATA0 to physical bank 0 (62a) of logical bank 0 bank 0 (60a). Here, the write algorithm implemented by the controller 20, when operating in half-density mode, may first write DATA0 to physical bank 0 (62a) of logical bank 0 (60a) of the memory array 22. Thereafter, the controller 20 may further write DATA0 to physical bank 2 (62c) in the duplicate bank 0 (60b) associated with logical bank 0 (60a). Thus, DATA0 is duplicated in the duplicate bank 0 (60b). A similar write operation is further illustrated by the WRITE command 82, in which another segment of data, referred to here as DATA 1, is written to physical bank 4 (62e) of the directly addressable logical bank 1 (60c) and duplicated in physical bank 6 (62g) of its associated duplicate bank 60d.

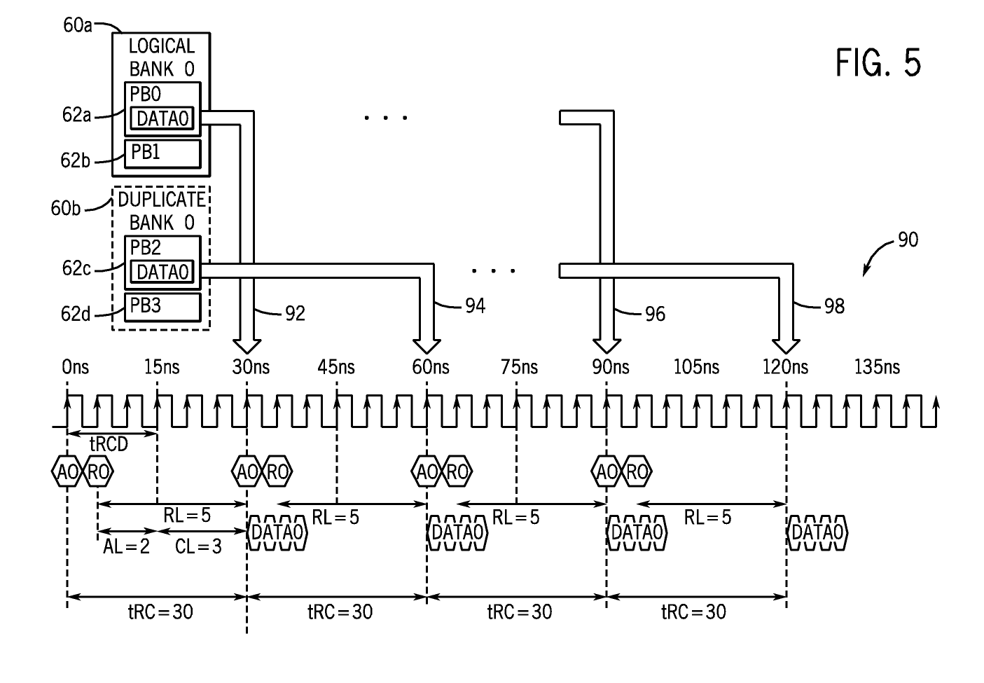

As discussed above, the duplicate banks 60b, 60d, 60f, and 60h are “inactive” in the sense that when operating in the half-density mode, these duplicate banks are not directly addressable by a WRITE command issued by the processor 12. Rather, from the viewpoint of the processor 12, the memory array 22, when operating in half-density mode, has four directly addressable logical banks. When a WRITE command to write data to any of the directly addressable logical banks is received from the processor 12, the controller 20 instructs the memory device 10, such as by providing appropriate control signals 44 to the bank control logic 46, to write the data to the logical bank addressed by the WRITE command, and to additionally write the data to a duplicate bank associated with the directly addressed logical bank. However, it should be noted that an external device, such as the processor 12, may not have visibility of the write operation performed to the duplicate bank, and that such operations are carried out under the control of the memory controller 20. Further, as will be appreciated, because the write operations to a directly addressable bank and its associated duplicate bank are performed sequentially in half-density mode, a write operation in this mode may require more clock cycles to complete (e.g., to complete (e.g., approximately twice as many clock cycles). However, as will be discussed with respect to FIG. 5, this duplication of the write data may provide for an effectively reduced tRC when reading the data from the memory array 22 while operating in the half-density mode.

Referring now to FIG. 5, a timing diagram 90 depicting read operations for reading DATA0 from physical bank 0 (62a) of logical bank 0 (60a) of the memory array 22 when operating in the half-density mode discussed in FIG. 4 is illustrated. As shown by the timing diagram 90, a first read request is initiated at 0 ns, wherein an ACTIVE command (A0) to activate logical bank 0 (60a) is issued, followed by a READ command (R0) to read DATA0 from logical bank 0 (60a). Following a read latency (RL) of 5 clock cycles, DATA0 may be read from physical bank 0 (62a) of logical bank 0 (60a) at 30 ns, as indicated by reference number 92.

Next, at 30 ns, a second read request is initiated by an ACTIVE command (A0) and READ command (R0). From the viewpoint of the processor 12, the commands A0 and R0 that are issued at 30 ns are no different than the commands A0 and R0 issued at 0 ns. However, from the viewpoint of the controller 20, because the tRC of physical bank 0 (62a) prevents this bank from being activated again at 30 ns, the controller 20 effectively “forwards” the second read request to duplicate bank 0 (60b), thereby activating the physical bank 2 (62c) in which the duplicate of DATA0 is stored. Thus, following a read latency of 5 clock cycles, DATA0 may be read from physical bank 2 (62c) of duplicate bank 0 (60b) at 60 ns, as indicated by reference number 94.

Subsequently, a third read request addressing logical bank 0 (60a) may be initiated, as shown by the ACTIVE (A0) and READ (R0) commands issued by the processor 12 at 60 ns. In the present example, the tRC of physical bank 2 (62c) of duplicate bank 0 (60b) has not yet elapsed, and thus physical bank 2 (62c) may not be activated at 60 ns. However, because the tRC of 55 ns has since elapsed with respect physical bank 0 (62a) of logical bank 0 (60a), physical bank 0 (62a) is available and may be activated in response to the request at 60 ns. Thus, the controller 20, upon receiving the ACTIVE (A0) and READ commands (R0) at 60 ns for reading DATA0, may activate physical bank 0 (62a) and carry out the READ command (R0). Accordingly, DATA0 may be read out again from physical bank 0 (62a) at 90 ns, as shown in timing diagram 90 and referred to by reference number 96.

Thereafter, a fourth read request addressing logical bank 0 (60a) may be initiated, as shown by the ACTIVE (A0) and READ (R0) commands issued by the processor 12 at 90 ns. In the present example, the tRC of physical bank 0 (62a) of logical bank 0 (60a) has not yet elapsed and, accordingly, physical bank 0 (62c) may not be activated at 90 ns. However, because the tRC of 55 ns has now elapsed with respect physical bank 2 (62c) of duplicate bank 0 (60b), physical bank 2 (62c) is available and may be activated. Thus, the controller 20, upon receiving the ACTIVE (A0) and READ commands (R0) at 90 ns may activate physical bank 2 (62c) and carry out the READ command (R0) thereto. Following the read latency time (RL), DATA0 may be read from physical bank 2 (62c) at 120 ns, as indicated by reference number 98.

Thus, as shown in FIG. 5, read commands issued to logical bank 0 (60a) by the processor 12 are interleaved between a logical bank 0 (60a) and its associated duplicate bank 0 (60b) in order to mask the full tRC of the directly addressed bank of the memory array 22. In other words, the tRC of each individual physical bank within the memory array 22 remains the same. However, the manner in which read requests for DATA0 are interleaved between an addressable bank (e.g., physical bank 0 (62a)) and an associated duplicate bank (e.g., physical bank 2 (62c)) storing a duplicate copy of the same data (e.g., using the duplicating write operations shown in FIG. 4) effectively provides for a reduced tRC, such that DATA0 may be read repeatedly from the memory array 22 at time intervals less than the full tRC (e.g., 55 ns) of the memory array 22.

Further, it will be appreciated by those skilled in the art that the memory controller 20 may implement any suitable technique for monitoring the status of memory banks based on row cycle latency times to determined when ACTIVE commands may be issued, such as by using timers/counters, status registers, pointers, and so forth. For example, in the half-density operation mode illustrated in FIGS. 4 and 5, the controller 20 may utilize one or more status registers and a timer to indicate whether physical bank 0 or the duplicate physical bank (physical bank 2 (62c) of duplicate logical bank 0 (60b)) is available to respond to a read request for DATA0. For example, once a physical bank 0 (62a) receives an ACTIVE command, a value or state may be written to a status register indicating that physical bank 0 (62a) is unavailable. At the same time, a counter may be initiated to count a number of clock cycles corresponding to the tRC. For example, if the tRC is 55 ns and each clock cycle is 5 ns, the counter may count for 11 clock cycles before resetting the status register to indicate that physical bank 0 (62a) is available to receive ACTIVE commands. During this time, however, if additional read requests to physical bank 0 (62a) are initiated by the processor 12, the controller 20 may be configured to forward the read request to the duplicate bank 0 (60b). As mentioned above, the steps of determining how to interleave the read requests, as determined by the controller 20, are generally not visible to the processor 12. not visible to the processor 12. Thus, from the viewpoint of the processor 12, the memory device 10, in response to repeated read requests for a particular segment of data (e.g., DATA0), is capable of outputting the requested data every 30 ns.

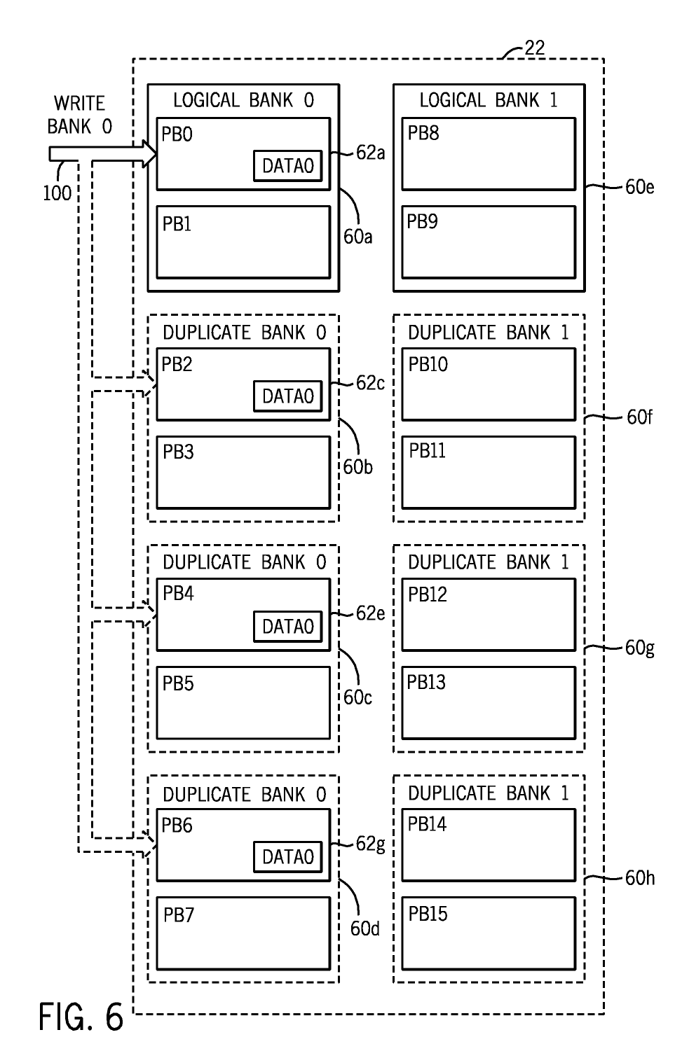

Continuing now to FIG. 6, the memory array 22 of FIG. 2 is illustrated in a quarter-density mode of operation. In this mode, a quarter of the logical banks 60 within the memory array 22 remain as directly addressable banks, and the remaining logical banks are configured as inactive “duplicate” banks, each associated with a respective directly addressable bank. By way of example, in the present configuration, logical banks 60a and 60e are configured as directly addressable banks. Logical banks 60b-d are configured as duplicate banks associated with logical bank 0 (60a), and logical banks 60f-h are configured as duplicate banks associated with logical bank 1 (60e). Again, it should be understood that the particular selection of directly addressable and inactive (duplicate) logical banks may vary among different embodiments. Regardless of such a selection, however, it should be appreciated that the quarter-density mode of operation shown in FIG. 6 provides three duplicate logical banks for each directly addressable logical bank.

As shown in FIG. 6, a WRITE command 100 that may be performed in the quarter-density mode of operation is illustrated. The WRITE command 100 represents a command to write DATA0 to physical bank 0 (62a) of logical bank 0 (60a), and is generally similar to the duplicating write operation depicted in the half-density write operation shown in FIG. 4 (e.g., WRITE command 80), but with the writing of DATA0 being duplicated three times, once to each of the duplicate banks 60b, 60c, and 60d associated with logical bank 0 (60a). By way of example, the write algorithm implemented by the controller 20, when operating in the quarter-density mode, may first write DATA0 to physical bank 0 (62a) of logical bank 0 (60a) of the memory array 22. Thereafter, the controller 20 may write DATA0 to physical bank 2 (62c) in the duplicate bank 60b. The controller 20 may then write DATA0 to physical bank 4 (62e) in the duplicate bank 60c and to physical bank 6 (62g) of the duplicate bank 60d.

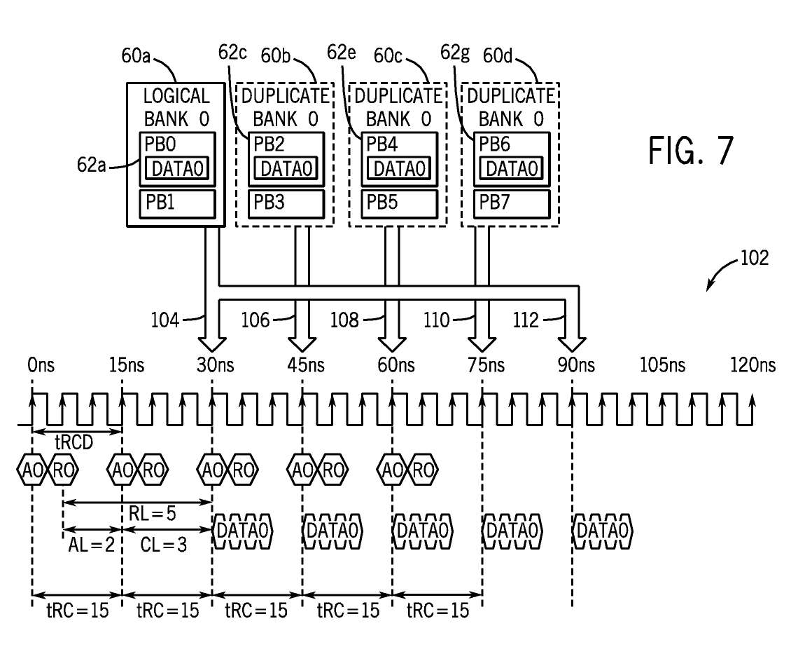

In other words, DATA0 is written to the directly addressable target physical bank 0 (62a), and then duplicated into each of the duplicate banks 60b-60d. Again, it should be understood that the duplicate banks 60b-60d are “inactive” in the sense that are not directly addressable by the processor 12 when issuing a WRITE command, as the processor 12 may not have visibility with regard to the duplicate banks 60b-d (and 60f-h) of the memory array 22. Instead, when a WRITE command (e.g., 100) is issued, the controller 20 instructs the memory device 10 (e.g., by control signals 44 to the bank control logic 46) to duplicate the written data to each of the duplicate banks associated with the logical bank directly addressed by the issued WRITE command. Additionally, because the write operations to an addressable bank and its associated duplicate banks are performed sequentially in the quarter-density mode, a write operation in this mode may require more clock cycles to complete (e.g., approximately four times as many clock cycles). However, as will be discussed with respect to FIG. 7, the presently illustrated quarter-density mode of operation may further reduce the tRC when repeatedly reading a segment of data from the memory array 22.

Referring now to FIG. 7, a timing diagram depicting read operations for reading DATA0 from physical bank 0 (62a) of logical bank 0 (60a) of the memory array 22 when operating in the quarter-density mode discussed in FIG. 6 is illustrated and generally referred to by reference number 102. As depicted by the timing diagram 102, the reading of DATA0 from the memory array 22 is performed in a similar interleaved manner as the half-density embodiment shown in FIG. 5, except that the read requests are interleaved between four banks of the memory array, namely logical bank 0 (60a) and each of its three associated duplicate banks 60b, 60c, and 60d, thus providing for an effective tRC of approximately 15 ns between ACTIVE commands.

For example, as illustrated by the timing diagram 102, ACTIVE commands (A0), each followed by a READ command (R0) to logical bank 0 (60a) are received at times 0 ns, 15 ns, 30 ns, 45 ns, and 60 ns. A first read operation, which begins at 0 ns, activates physical bank 0 (62a) of logical bank 0 (60a). Following the read latency (RL) time, DATA0 may be read from physical bank 0 (62a) at 30 ns, as indicated by reference number 104. Meanwhile, a second read operation is initiated at 15 ns. Because the tRC for physical bank 0 (62a) has not elapsed, the controller 20 may forward the ACTIVE command (A0) and READ command (R0) to the next available duplicate bank 60b. Thus, DATA0 may be read from physical bank 2 (62c) of duplicate bank 60b at 45 ns, as indicated by reference number 106.

Continuing along the timing diagram 102, a third read operation is initiated at 30 ns. At this point, the tRCs for physical bank 0 (62a) and physical bank 2 (62c) have not yet elapsed. Accordingly, the ACTIVE command (A0) and READ command (R0) received at 30 ns may be forwarded by the controller 20 to the next available duplicate bank 60c, whereby DATA0 is read from physical bank 4 (62e) of duplicate bank 60c at 60 ns, as indicated by the reference number 108. Next, a fourth operation is initiated at 45 ns. Here, the tRC (e.g., 55 ns) for physical bank 0 (62a), physical bank 2 (62c), and physical bank 4 (62e) have not yet elapsed. As such, the controller 20 may forward the ACTIVE command (A0) and READ command (R0) received at 45 ns to the final duplicate bank 60d associated with logical bank 0 (60a). Thus, DATA0 may be read from physical bank 6 (62g) at 75 ns, as indicated by reference number 110.

Referring now to the fifth read operation initiated at 60 ns, it should be noted that at this point of the timing diagram 102, the duplicate physical banks 62c, 62e, and 62g cannot be activated because their respective tRCs have not fully elapsed. However, because the present embodiment utilizes a tRC of 55 ns, physical bank 0 (62a) is available since 60 ns have elapsed since physical bank 0 was last activated at 0 ns. Thus, the ACTIVE command (A0) and READ command (R0) received at 60 ns may result in DATA0 being read out again from physical bank 0 (62a) of logical bank 0 (60a), as indicated by reference number 112.

As will be appreciated, the process of interleaving read requests using the illustrated quarter-density mode of operation essentially repeats from this point forward. That is, a subsequent read command received at 75 ns would be issued to duplicate bank 60b by the controller 20, a subsequent read command received at 90 ns would be issued to duplicate bank 60c by the controller 20, and so forth. In other words, read commands issued to logical bank 0 (60a) by the processor 12 are interleaved between logical bank 0 (60a) and the corresponding duplicate banks 60b-60d to mask the tRC of the individual physical banks of the memory array 22. Using this technique of interleaving the read requests between the addressable bank and the three corresponding duplicate banks, each storing duplicate copies of DATA0 (e.g., using the duplicating WRITE command 100 shown in FIG. 6), an effective tRC that is even further reduced compared to the half-density mode illustrated in FIG. 5 is achieved, whereby DATA0 may be read repeatedly from the memory array 22 at approximately every 15 ns. That is, from the viewpoint of the processor 12, the memory device 10, in response to repeated read requests for a particular segment of data (e.g., DATA0), is capable of outputting the requested DATA0 every 15 ns. As will be appreciated, this is less than half the tRC of the physical banks of the array 12.

Additionally, it should also be appreciated that the controller 20 may utilize any suitable technique for managing the interleaving of the read commands issued to physical bank 0 (62a), such as the counter/register scheme discussed above, or by using a pointer that is incremented after each directly addressable physical or duplicate bank is activated. For instance, the pointer may be reset once the directly addressable bank and all its associated duplicate banks have been activated.

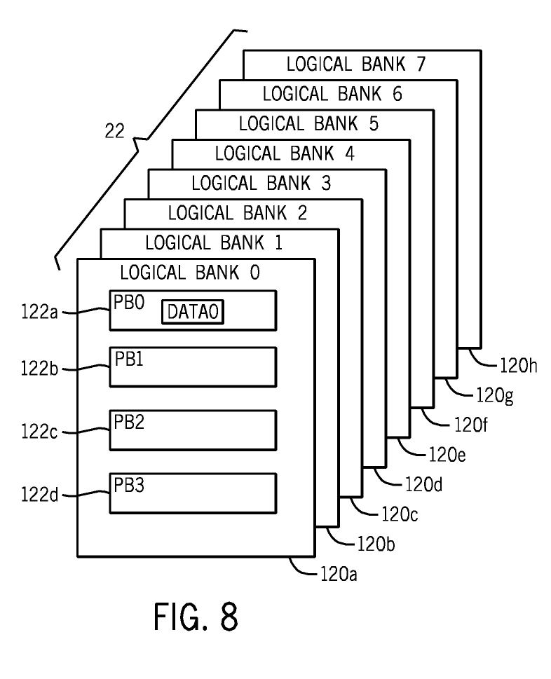

Referring now to FIG. 8, an alternate layout of the memory array 22 of the memory device 10 of FIG. 1 is illustrated. Here, rather than utilizing the 8-logical bank/16-physical bank configuration shown in FIG. 2, the present embodiment provides an 8-logical bank/32-physical bank arrangement, in which each logical bank, referred to here by reference numbers 120a-120h, includes four addressable physical banks 122. For example, logical bank 0 (120a) may include physical banks 0-3, referred to by reference numbers 122a-122d, respectively, and logical bank 1 (120b) may include physical banks 4-7 (not shown in FIG. 8). By way of example, if the memory array 22 has a total size of 1 GB, each logical bank 120 may have a size of 128 Mb and each physical bank 122 may have a size of 32 Mb. In the illustrated embodiment, the memory array 22 array 22 is shown as operating in a full density mode with a tRC of 55 ns. Thus, a WRITE command for writing a segment of data (DATA0) to logical bank 0 may be generally similar to the full-density write operation described above with respect to FIG. 2, resulting in DATA0 being stored in physical bank 0 (122a) of logical bank 0 (120a).

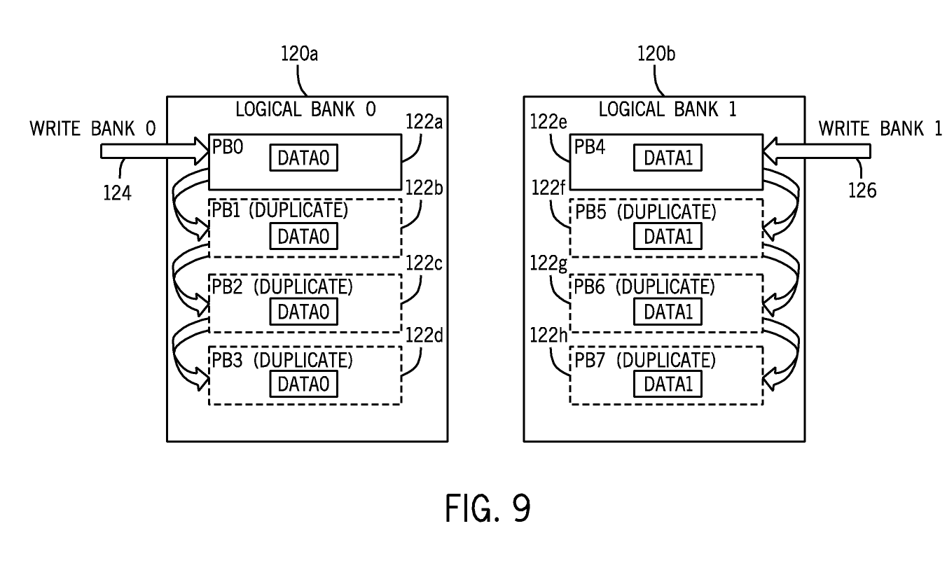

FIG. 9 shows the memory array 22 of FIG. 8 when configured to operate in a quarter-density mode, in accordance with an embodiment of the present invention. The present embodiment differs from the quarter-density configuration shown in FIG. 6 in that rather than utilizing “inactive” logical banks as duplicate banks, the presently illustrated quarter-density configuration provides for two directly addressable logical banks, shown here as logical bank 0 (120a) and logical bank 1 (120b), each of which may include a directly addressable physical bank and three duplicate physical banks. For example, logical bank 0 (120a) may include physical bank 0 (122a), and physical banks 1-3 (122b-122d), which function as its duplicate banks. Similarly, logical bank 1 (120b) may include physical bank 4 (122e), as well as physical banks 5-7 (122f-h), which function as its duplicate banks. In other words, rather than duplicating data into different logical banks, the present configuration provides for the duplication of data within each of the physical banks within a logical bank.

Referring now to the WRITE command 124, when operating in the presently illustrated quarter-density mode, the controller 20 may implement a write algorithm that writes a first data segment DATA0 into physical bank 0 (122a) of logical bank 0 (120a). Thereafter, the first data segment DATA0 is also written into duplicate physical banks 122b-122d, such that all physical banks within logical bank 0 store a copy of DATA0. A similar write command 126 is illustrated illustrated with respect to logical bank 1 (120b), in which a second data segment DATA1 is written into physical bank 4 (122e), and then duplicated into associated duplicate banks 122f-122h using successive write operations to each duplicate bank.

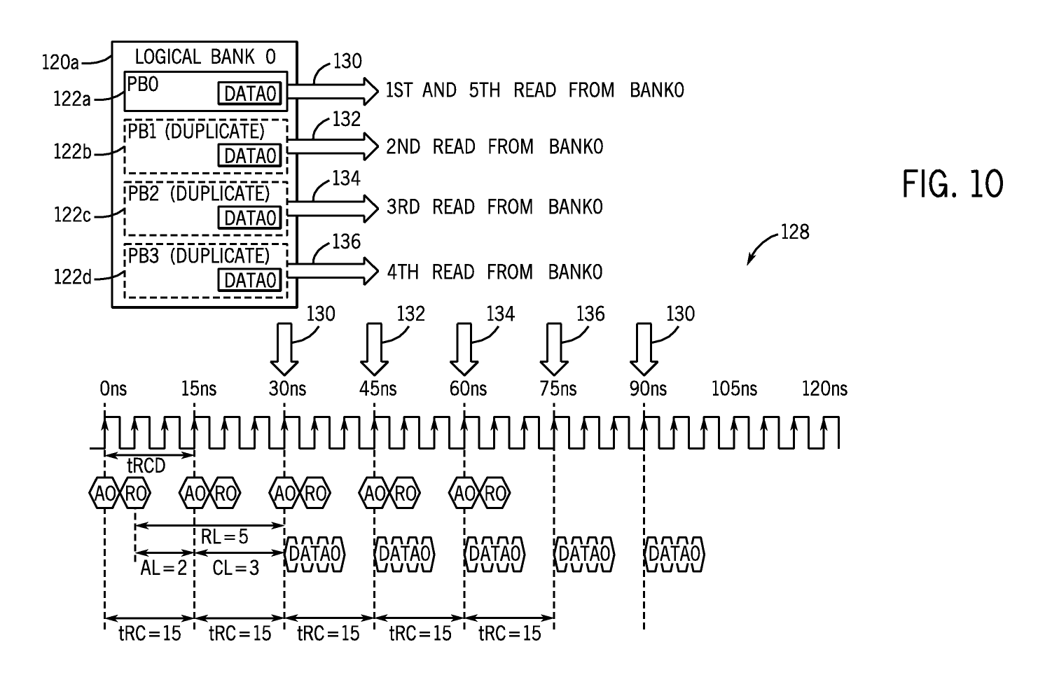

Referring now to FIG. 10, a timing diagram depicting read operations for reading DATA0 from physical bank 0 (122a) of logical bank 0 (120a) of the memory array 22 when operating in the quarter-density mode discussed in FIG. 9 is illustrated and generally referred to by reference number 128. As will be appreciated, read requests to physical bank 0 (122a) may be interleaved in a manner similar to the technique illustrated in FIG. 7, except that the read requests are interleaved between the physical banks 122a-122d within the same logical bank 120a as opposed to physical banks from different duplicate logical banks. For example, in the present timing diagram 128, read commands issued by the processor 12 to physical bank 0 (122a) may be interleaved between physical bank 0 (122a) and duplicate physical banks 122b, 122c, and 122d to provide for an effective tRC of approximately 15 ns.

As shown by the timing diagram 128, ACTIVE commands (A0), each followed by a READ command (R0) to logical bank 0 (120a) are issued by the processor 12 at times 0 ns, 15 ns, 30 ns, 45 ns, and 60 ns. A first read operation, which begins at 0 ns, activates physical bank 0 (122a), whereby DATA0 may be read from physical bank 0 (122a) at 30 ns, as indicated by reference number 130, following a read latency (RL) time equivalent to 5 clock cycles. A second read operation is initiated at 15 ns. As explained above, the tRC for physical bank 0 (122a) has not elapsed and, thus, the controller 20 may forward the ACTIVE command (A0) and READ command (R0) received at 15 ns to the duplicate bank 122b. Accordingly, DATA0 may be read from duplicate bank 122b at 45 ns, as indicated by reference number 132.

Continuing along timing diagram 128, a third read operation is initiated at 30 ns. At this point, the tRCs for physical bank 0 (122a) and duplicate bank 122b have not yet elapsed. Thus, the controller 20 may forward the ACTIVE command (A0) and READ command (R0) received at 30 ns to the next available duplicate bank 122c, whereby DATA0 is read from duplicate bank 122c at 60 ns, as indicated by the reference number 134. Next, a fourth read operation is initiated at 45 ns. Here, the tRCs for physical bank 0 (122a) and duplicate banks 122b and 122c have not yet elapsed. As such, the controller 20 may forward the ACTIVE command (A0) and READ command (R0) received at 45 ns to the final duplicate bank 122d within logical bank 0 (120a). Thus, DATA0 may be read from duplicate bank 122d at 75 ns, as indicated by reference number 136.

Referring now to the fifth read operation, which is initiated at 60 ns, the duplicate physical banks 122b, 122c, and 122d cannot be issued ACTIVE commands because their tRCs have not fully elapsed. However, because the memory array 22 of the present embodiment has a tRC of 55 ns, physical bank 0 (122a) is available because at least 55 ns have elapsed since physical bank 0 was last activated at 0 ns. Thus, the ACTIVE command (A0) and READ command (R0) received at 60 ns may result in DATA0 being read out from physical bank 0 (122a) again at 90 ns, as indicated by reference number 130. As will be appreciated, additional read requests received from this point forward may essentially repeat the interleaved manner of reading of DATA0 from the physical banks 122a-122d of logical bank 0 (120a). For instance, a sixth ACTIVE and READ sixth ACTIVE and READ command at 75 ns may be issued to duplicate bank 122b, a seventh ACTIVE and READ command at 90 ns may be issued to duplicate bank 122c, and so forth.

As discussed above, the interleaving of the read requests using the quarter-density mode in the manner described herein provides for an effective tRC that, from the viewpoint of the processor 12, may be significantly less than the tRC of the individual physical banks of the memory array 22. For instance, in the present example, DATA0 may be read repeatedly from the memory array 22 at approximately every 15 ns, whereas the tRC of any single physical bank is 55 ns. Additionally, it should also be understood that the memory controller 20 may utilize any suitable technique for managing the interleaving of the read requests between physical banks 122a-122d, such as by using the counter/register scheme discussed above, or via using a pointer that is incremented after each directly addressable physical or duplicate physical bank is activated, such that a subsequently received ACTIVE command is directed to a different physical bank address within the logical bank 0 (120a).

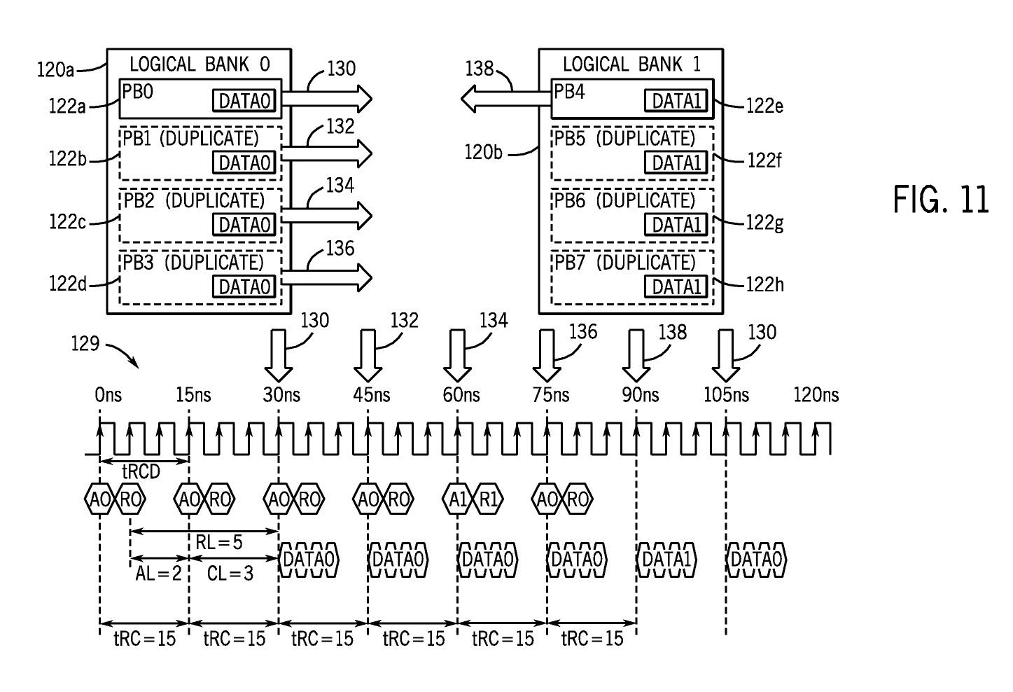

While the memory device 10 discussed in the above embodiments has generally been referred to as a DDR SDRAM device having a tRC of 55 ns, it should be understood that this particular timing is provided merely by way of example. For instance, in some faster DDR3 SRDAM devices, tRCs as low as approximately 45 ns for each physical bank may be achieved. Still, in other embodiments, tRCs may also be greater than 55 ns. For example, referring now to FIG. 11, a timing diagram 129 is provided and depicts read operations for reading DATA0 from physical bank 0 (122a) of logical bank 0 (120a) of the memory array 22 when operating in the quarter-density mode discussed in FIG. 9, but wherein the memory array 22 has a greater tRC of approximately 65 ns.

As shown by the timing diagram 129, first, second, third, and fourth read requests (including an ACTIVE and READ command) are initiated by the processor 12 at times corresponding to 0 ns, 15 ns, 30 ns, and 45 ns, respectively. The first read request at 0 ns may result in DATA0 being read out from physical bank 0 (122a) at 30 ns, as discussed above and indicated by reference number 130. The second read request to physical bank 0 (122a) at 15 ns may be forwarded by the controller 20 to duplicate bank 122b, whereby DATA0 is read out from duplicate bank 122b at 45 ns, as indicated by reference number 132. Next, the third read request to physical bank 0 (122a) at 30 ns may be forwarded to the duplicate bank 122c. Thus, at 60 ns, DATA0 may be read out from duplicate bank 122c, as indicated by reference number 134. Further, the fourth read request to physical bank 0 (122a) at 45 ns may be forwarded by the controller 20 to the duplicate bank 122d, whereby DATA0 is read out from the duplicate bank 122d at 75 ns, as indicated by reference number 136.

As mentioned above, in the present example, the tRC of each physical bank is 65 ns. Thus, at 60 ns, none of the physical banks 122a-122d within logical bank 0 (120a) is available to receive an ACTIVE command. Thus, the controller 20 may either wait until a physical bank is available or, as shown in FIG. 11, the controller 20 may alternatively interleave a read request to a physical bank in another logical bank. For instance, as shown in the illustrated embodiment, at 60 ns, the controller 20 may receive a request to read DATA1 from physical bank 4 (122e) of logical bank 0 (120b). Thus, since additional reads to logical bank 0 are unavailable due to the 65 ns tRC, the controller 20 may respond to the read request for DATA1 by activating physical bank 4 (122e) of logical bank 1 (120b), and outputting DATA1 (e.g., via data-out circuitry 40) at 90 ns, as shown by reference number 138. Meanwhile, at 75 ns, because the tRC has elapsed with regard to physical bank 0 (122a) of logical bank 0 (120a), a subsequent read request to logical bank 0 may be processed, whereby DATA0 is read out again from physical bank 0 (122a) at 105 ns. Thus, it should be understood that in providing for the reduced tRC in reading data from the memory array 22 when operating in one or more of the reduced density modes discussed above, the controller 20 may implement any suitable type of interleaving techniques to mask the tRC of the physical banks of the memory array 22, including interleaving read requests for a second segment of data (e.g., DATA1) when necessary in order for enough clock cycles to pass such that at least one bank containing a first segment of data (e.g., DATA0) becomes available to receive subsequent read requests. Additionally, in another embodiment, DATA0 may also be written to the physical banks of logical bank 1 (120a) (instead of DATA1) in response to a WRITE command implemented by the controller 20. Thus, based upon the timing diagram 129 shown in FIG. 11, from the viewpoint of the processor 12, DATA0 may be read out from the memory array every 15 ns, wherein the fifth read request at 60 ns is addressed to a different logical bank.

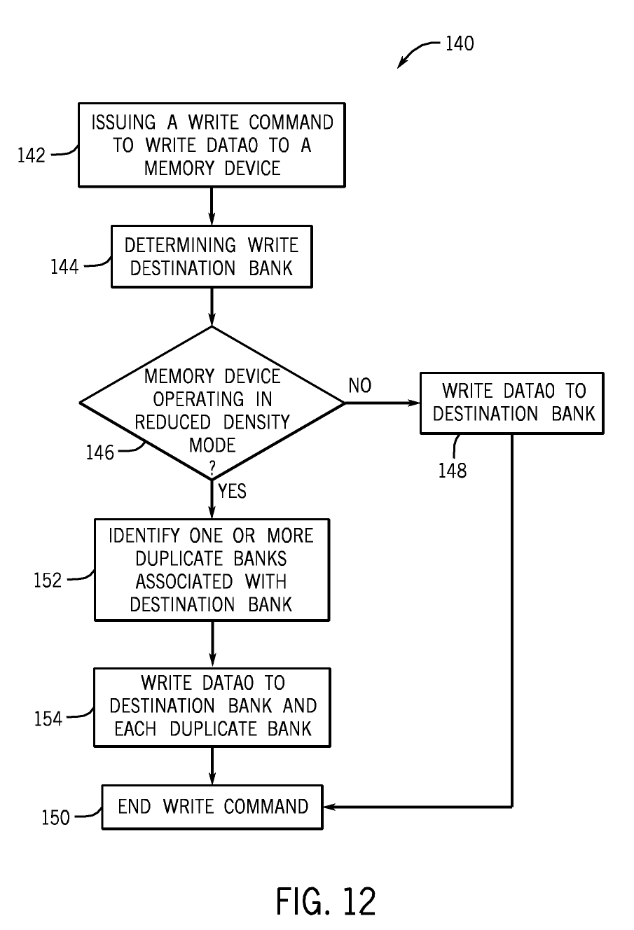

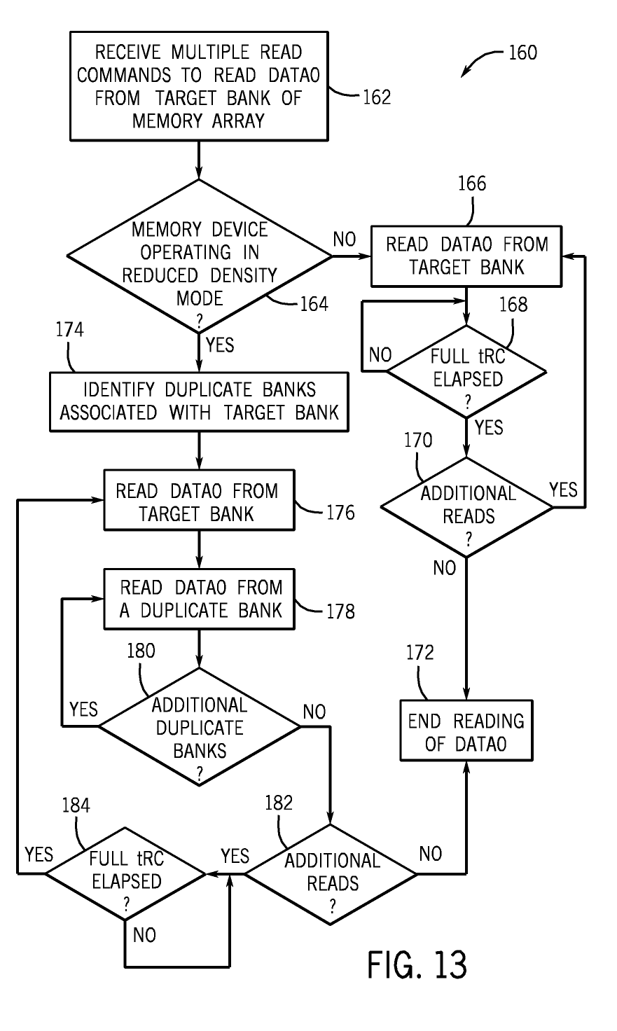

The above-discussed techniques may be further illustrated by the flowcharts depicted in FIGS. 12 and 13. Specifically, FIG. 12 depicts a method for writing data to a memory device, and FIG. 13 depicts a method for reading data from a memory device, in accordance with the embodiments of the present invention generally discussed above. Referring first to FIG. 12, a method 140 begins at step 142, wherein a WRITE command (e.g., issued by the processor 12) for writing a segment of data, DATA0, to a memory array 12 is received by the memory device 10. At step 144, a destination bank to which DATA0 is to be written is determined. By way of example, the destination bank may be determined via row, column, and bank address signals received on the address bus 16, as discussed above with reference to FIG. 1. At decision step 146, a determination is made as to whether the memory device 10 is operating in a full or reduced density mode of operation. If the memory device 10 is operating in a full density mode, the method 140 continues to step 148, wherein DATA0 is written to the destination bank determined at step 144. Thereafter, the method 140 may proceed to step 150, wherein the write operation concludes.

Returning to decision step 146, if it is determined that the memory device 10 is operating in a reduced density mode of operation, one or more duplicate banks that may be associated with the destination bank determined at step 144 are identified at step 152. Duplicate banks may include other “inactive” logical banks, as discussed above with reference to FIGS. 4 and 6, or may include physical banks from within the same logical bank, as discussed above with reference to FIG. 9. Additionally, depending on the layout of the memory array 22 and the reduced density mode being utilized, the number of duplicate banks may vary. For instance, in the 8-logical bank example shown in FIG. 2 above, each addressable logical bank may be associated with one duplicate logical bank in a half-density mode of operation, or three duplicate logical banks when operating in a quarter-density mode of operation. Thereafter, at step 154, DATA0 is written to the destination bank as well as each associated duplicate bank. Afterwards, the write operation ends at step 150.

Referring now to FIG. 13, a method 160 for reading data from a memory device 10 following the write operation depicted in FIG. 12 is illustrated, in accordance with aspects of the present disclosure. The method 160 begins at step 162, in which a memory device 10 receives multiple read requests for reading DATA0 from a target bank (which is a bank directly addressable by the processor) in which DATA0 is stored. At step 164, a determination is made as to whether the memory device 10 is operating in a full or reduced density mode or operation. If the memory device 10 is operating in a full density mode, the method 160 continues to step 166, wherein DATA0 is read from the target bank. Next, at step 168, a determination is made as to whether the tRC for the target bank has elapsed. As discussed above, the target bank cannot be activated to receive additional read requests until the tRC has elapsed. Accordingly, if the tRC has not elapsed, the method 160 returns to decision block 168. If the tRC has elapsed and the target bank may be issued a subsequent ACTIVE command, then the method 160 continues to step 170, at which a determination is made as to whether an additional read request has been received. If an additional read request has been received, the method 160 returns to step 166, whereby DATA0 is read out from the target bank again. Returning to step 170, if no additional read requests for DATA0 are received, the method 160 concludes at step 172.

Returning to step 164, if it is determined that memory device 10 is operating in a reduced density mode of operation, the method 160 proceeds to step 174, in which one or more duplicate banks that may be associated with the target bank are identified. Next, at step 176, DATA0 is read from the target bank. Thereafter, at step 178, in response to a subsequent read request from the multiple read requests received at step 162 above, DATA0 is read from a duplicate bank. Continuing to decision step 180, a determination is made as to whether additional additional duplicate banks are available. As discussed above, by interleaving read requests for DATA0 between the target bank and its duplicate banks, the effective tRC may be reduced from the viewpoint of the processor 12. As will be appreciated, the number of duplicate banks may depend on the layout of the memory array 22 and the reduced density mode being utilized. For instance, the 8-logical bank arrangement shown in FIG. 2 above may provide one duplicate bank for each directly addressable logical bank in a half-density configuration, and may provide three duplicate banks for each directly addressable logical bank in a quarter-density configuration. If it is determined that additional duplicate banks are available, the method 160 returns to step 178, wherein subsequent read requests to the target bank may be forwarded to an appropriate duplicate bank, and wherein DATA0 is read from that duplicate bank.

Returning to step 180, if no additional duplicate banks are available, a determination is made at step 182 as to whether additional read commands for DATA0 have been issued by the processor 12. If additional read commands have been issued, then the method 160 continues to decision step 184 to determine whether the tRC for the target bank has elapsed. As shown in FIG. 13, if the tRC has not elapsed and the target bank is not available to receive an ACTIVE command, the method 160 returns to step 184 and waits for the tRC to elapse. Alternatively, if it is determined at step 184 that the target bank is available, then the method returns to step 176, at which DATA0 is read out from the target bank again. Finally, referring back to step 182, if no duplicate banks are available and no additional read commands have been issued (e.g., by processor 12), the method 160 concludes at step 172.

It should be understood that the specific memory array 22 layouts (e.g., 1 Gb memory array having 8-logical banks and 16 physical banks or 32 physical banks) and timing schemes (e.g., tRC=60 ns at full density mode; tRC=30 ns at half-density mode; and tRC=15 ns at quarter-density mode) discussed above are provided merely by way of example in order to facilitate and simplify the discussion of the configurable density and latency features of the memory devices disclosed herein. Indeed, it should be appreciated that embodiments of the present invention may utilize any suitable timing configuration or layout depending on the specific needs for a particular implementation.

For instance, as discussed above, the presently disclosed techniques may be particularly useful in applications, such as high-speed network routing, in which a generally static segment of data, such as a NAT table is subject to a high frequency of read requests. Thus, to implement a reduced density operation mode on a memory device storing the NAT table, the memory array 22 may be selected based upon the size of the NAT table. For instance, if the total size of the NAT table is less than 64 Mb, then a 1 Gb array utilizing 16 physical banks arranged in 8 logical banks, as shown in FIG. 2, may be utilized. That is, the NAT table may be suitably stored and duplicated into any single physical bank (64 Mb) of such an array and, therefore, the half-density or quarter-density modes of operation may be carried out in the manner described above. Alternatively, if the NAT table is larger than 64 Mb, then a larger memory array 22 may be selected. For instance, if 80 Mb is required to store the NAT table, then a 2 Gb array utilizing the layout shown in FIG. 2, wherein each physical bank is capable of storing 128 Mb, may be selected.

It should be further appreciated that the present technique offers several advantages over conventional methods for reducing or masking tRC. As mentioned above, one conventional technique for reducing tRC in applications includes providing SRAM devices or RLDRAM devices with lower tRCs in place of conventional DRAMS or SDRAMS. While it is possible to provide tRCs of as low as 15 ns using such devices, those skilled in the art will appreciate that SRAMs and RLDRAMs are typically substantially higher in cost relative to SDRAM devices. Additionally, the power consumption of an SRAM or RLDRAM device is also generally higher than a typical SDRAM device having comparable storage capacities, due at least partially to increased complexity in the memory circuitry of SRAM and RLDRAM architectures.

Another conventional technique for reducing tRC relates to interleaving read requests for a segment of data copied among a plurality of DRAM devices. As mentioned above, however, this technique not only requires that multiple DRAM devices be provided, but may also require a separate control circuitry to manage the interleaving of read requests between the multiple devices, thus disadvantageously increasing costs, bus turn-around times, and amount of component space required relative to using a single memory device. Thus, the presently disclosed techniques, which may be carried out using a single DRAM device, greatly reduces the cost and complexity of such conventional multiple device configuration for masking tRCs.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents equivalents and alternatives falling within the spirit and scope of the invention as defined by the following appended claims.

What is claimed is:

1. A memory device, comprising:
a memory array divided into a plurality of divisions; and
a memory controller configured to select one of either a full density mode of operation or one or more reduced density modes of operation;
wherein, if the full density mode is selected by the memory controller, each of the plurality of divisions is directly addressable by a command issued to the memory device by an external device; and
wherein, if one of the reduced density modes of operation is selected by the memory controller, only a portion of the plurality of divisions within the memory array is directly addressable by the command issued to the memory device by the external device, and wherein at least one of the plurality of divisions that is not directly addressable by the external device functions as a duplicate to an associated one of the directly addressable divisions.

2. The memory device of claim 1, wherein the divisions are memory banks, and wherein, if the memory device is operating in a reduced density mode, the memory controller, in response to a write command to write a data segment to the memory array, is configured to write the data segment to a memory bank directly addressed by the write command and to write the data segment to at least one memory bank associated with the directly addressed memory bank.

3. The memory device of claim 2, wherein, in response to repeated read commands issued by the external device for reading the data segment from the directly addressed memory bank, the memory controller is configured to interleave the read commands between the directly addressed memory bank and each of its associated memory banks, such that the time interval between each read out of the data segment from the memory array in response to a respective read command is less than the row cycle time of the directly addressed memory bank.

4. The memory device of claim 3, wherein the directly addressed memory bank and its associated memory banks are physical banks within a common logical bank, and wherein the read commands are interleaved between the physical banks within the common logical bank.

5. The memory device of claim 3, wherein the one or more reduced density modes of operation includes a half-density mode of operation and a quarter-density mode of operation.

6. The memory device of claim 5, wherein the memory array comprises eight logical banks;
wherein the memory array is configured to, when operating in the half-density mode of operation, provide four directly addressable logical banks and four duplicate logical banks, wherein each duplicate logical bank is associated with a respective one of the four directly addressable logical banks; and
wherein the memory is configured to, when operating in the quarter-density mode of operation, provide two directly addressable logical banks and six duplicate logical banks, wherein each of the directly addressable logical banks is associated with three duplicate logical banks.

7. The memory device of claim 6, wherein the memory device is configured to, when operating in the half-density mode, process the repeated read commands for reading the data segment from the directly addressed memory bank using the memory controller, such that the read commands are interleaved between the directly addressed logical bank and its associated duplicate logical bank.

8. The memory device of claim 6, wherein the memory device is configured to, when operating in the quarter-density mode, process the repeated read commands for reading the data segment from the directly addressed memory bank using the memory controller, such that the read commands are interleaved between the directly addressed logical bank and each of its three associated duplicate logical banks, such that the time interval between each read out of the data segment from the memory array in response to a respective read command is less than half the row cycle time.

9. The memory device of claim 1, comprising one of a synchronous dynamic random access memory (SDRAM), a dual-data-rate (DDR) SDRAM, a DDR2 SDRAM, a DDR3 SDRAM, or a DDR4 SDRAM.

10. A method for masking row cycle time latency in a memory device, comprising:
configuring a memory array having a plurality of memory banks based upon a selection of a reduced density mode of operation, such that a first set of banks is configured as banks addressable by an external device, and a second set of banks is configured as duplicate banks, wherein at least one of the duplicate banks is associated with one of the addressable banks;
writing a data segment to the memory array in response to a write command received from the external device, wherein writing the data segment comprises:
writing the data segment to one of the first set of banks addressed by the write command; and
writing the data segment to at least one of the second set of banks associated with the one of the first set of banks addressed by the write command; and
interleaving each of a plurality of consecutive read commands requesting the data segment between the one of the first set of banks and each associated one of the second set of banks, wherein the interval between each read out of the data segment from the memory array in response to a respective one of the plurality of read commands is less than the row cycle time of the one of the first set of banks addressed by the write command.

11. The method of claim 10, wherein the reduced density mode is a half-density mode of operation, wherein the addressed one of the first set of banks is associated with a respective one of the second set of banks, and wherein interleaving each of the plurality of consecutive read commands comprises:
receiving a first read command;
reading the data segment from the addressed one of the first set of banks in response to the first read command at a first time;
receiving a second read command;
reading the data segment from the associated respective one of the second set of banks in response to the second read command at a second time, wherein the difference between the first time and the second time is equal to a first value that is less than the row cycle time;
receiving a third read command; and
reading the data segment from the addressed one of the first set of banks in response to the third read command at a third time, wherein the difference between the second time and the third time is equal to the first value, and wherein the difference between the first and the third time is equal to or greater than the row cycle time.

12. The method of claim 11, wherein receiving the first, second, and third read commands comprises:
initiating a pointer that points to the addressed one of the first set of banks;
activating the addressed one of the first set of banks in response to the first read command;
incrementing the pointer, such that the pointer points to the associated respective one of the second set of banks;
activating the associated respective one of the second set of banks in response to the second read command; and
resetting the pointer, such that the pointer points to the addressed one of the first set of banks.

13. The method of claim 10, wherein the reduced density mode is a quarter-density mode of operation, wherein the addressed one of the first set of banks is associated with first, second, and third banks of the second set of banks, and wherein interleaving each of the plurality of consecutive read commands comprises:
receiving a first read command;
reading the data segment from the addressed one of the first set of banks in response to the first read command at a first time;
receiving a second read command;
reading the data segment from the first associated one of the second set of banks in response to the second read command at a second time, wherein the difference between the first time and the second time equal to a first value that is less than half the row cycle time;
receiving a third read command;
reading the data segment from the second associated one of the second set of banks in response to the third read command at a third time, wherein the difference between the second time and the third time is equal to the first value;
receiving a fourth read command;
reading the data segment from the third associated one of the second set of banks in response to the fourth read command at a third time, wherein the difference between the third time and the fourth time is equal to the first value;
receiving a fifth read command; and
reading the data segment from the addressed one of the first set of banks in response to the fifth read command at a fifth time, wherein the difference between the fourth time and the firth time is equal to the first value, and wherein the different between the first time and the fifth time is equal to or greater than the row cycle time.

14. The method of claim 13, wherein receiving the first, second, third, fourth, and fifth read commands comprises:
initiating a pointer that points to the addressed one of the first set of banks;
activating the addressed one of the first set of banks in response to the first read command;
incrementing the pointer, such that the pointer points to the first associated one of the second set of banks;
activating the first associated one of the second set of banks in response to the second read command;
incrementing the pointer, such that the pointer points to the second associated one of the second set of banks;
activating the second associated one of the second set of banks in response to the third read command;
incrementing the pointer, such that the pointer points to the third associated one of the second set of banks;
activating the third associated one of the second set of banks in response to the fourth read command; and
resetting the pointer, such that the pointer points to the addressed one of the first set of banks.

15. A system comprising:
a memory access device; and
a memory device coupled to the memory access device, wherein the memory device comprises:
a memory array comprising a plurality of memory banks; and
a memory controller configured to operate the memory array in either a full density mode or one or more reduced density modes of operation, wherein the memory controller is configured to, when the reduced density mode is selected, write a data segment to a memory bank addressed by a write command issued by the memory access device, write the data segment into one or more memory banks associated with the memory bank addressed by the write command, and interleave consecutive read requests between the addressed memory bank and its one or more associated memory banks, such that the time interval between each read out of the data segment from the memory array is less than the row cycle time of the addressed memory bank.

16. The system of claim 15, wherein the memory device comprises bank control logic configured to configure the banks of the memory array as a directly addressable bank or a duplicate bank based upon control signals provided by the memory controller, the control signals being determined at least partially upon the selection of either the full or one or more reduced density modes of operation.

17. The system of claim 16, wherein the memory controller comprises a status register configured to provide an indication of whether a directly addressable bank is available to respond to a read request.

18. The system of claim 17, wherein the indication provided by the status register is based upon a timer configured to count a number of clock cycles corresponding to a row cycle latency time of the directly addressable bank.

19. The system of claim 15, where the data segment represents a generally static segment of data.

20. The system of claim 19, wherein the data segment represents one of a network look up table or a network address translation table, and wherein the system comprises one of a network switch or a network router, or some combination thereof.

21. The system of claim 15, wherein the memory controller is configured to select the reduced density mode from one of a half-density mode of operation or a quarter-density mode of operation;
wherein, if the half-density mode is selected, each addressable memory bank is associated with one memory bank; and
wherein, if the quarter density mode is selected, each addressable memory bank is associated with three memory banks.

22. The system of claim 15, wherein the memory device comprises an SDRAM utilizing one of DDR, DDR2, DDR3, or DDR4 standards.

23. A memory controller comprising:
logic configured to write a data segment an addressed memory bank of a memory array in response to a write command issued by an external device, and to write the data segment into one or more memory banks associated with the addressed memory bank when the memory array is operating in a reduced density mode; and
logic configured to interleave consecutive read requests between the addressed memory bank and its one or more associated memory banks when the memory array is operating in a reduced density mode, wherein the time interval between each read out of the data segment is less than the row cycle time of the addressed memory bank.

24. The memory controller of claim 23, wherein the logic configured to interleave read requests between the addressed memory bank and its one or more associated memory banks comprises logic configured to:
initiate a pointer that points to the addressed memory bank;
read the data segment from the addressed memory bank;
increment the pointer for each subsequent to read request to each respective one or more associated memory banks; and
reset the pointer to point to the addressed memory bank once the data segment has been read from each respective one or more associated memory banks.

25. The memory controller of claim 23, comprising:
a timer configured to count a number of clock cycles corresponding to a row cycle latency time of the addressed memory bank; and
one or more status registers configured to indicate, based upon the timer, whether the addressed memory bank or its one or more associated memory banks are available to respond to a read request.

26. The memory controller of claim 25, comprising logic configured to, if the addressed memory bank and its associated one or more memory banks are not available to respond to the read request, issue another read request to read another data segment from another addressed memory bank.

27. A method for reading data from a memory array having a plurality of memory divisions, comprising:
reading out a segment of data from a first memory division at a first time; and
reading out the segment of data from a second memory division at a second time;
wherein the time interval between the first time and the second time is less than the row cycle time of the first memory division.

28. The method of claim 27, comprising:
reading out the segment of data from a third memory division at a third time; and
reading out the segment of data from a fourth memory division at a fourth time;
wherein the time interval between each of the first, second, third, and fourth times is less than half the row cycle time of the first memory division.

29. The method of claim 28, wherein the first, second, third, and fourth memory divisions comprise memory banks within the memory array.
